(19) United States
(12) Patent Application Publication
(10) Pub. No.: US 2024/0224038 A1
(43) Pub. Date: Jul. 4, 2024

(54) Indication Method for Status Variable of Multicast Service and Device

(71) Applicant: VIVO MOBILE COMMUNICATION CO., LTD., Dongguan (CN)

(72) Inventor: Jiamin Liu, Dongguan (CN)

(21) Appl. No.: 18/604,853

(22) Filed: Mar. 14, 2024

Related U.S. Application Data
(63) Continuation of application No. PCT/CN2022/119245, filed on Sep. 16, 2022.

(30) Foreign Application Priority Data
Sep. 18, 2021 (CN) 202111102087.X

(51) Int. Cl. H04W 12/106; H04L 12/18; H04W 12/08

(52) U.S. Cl. CPC H04W 12/106; H04L 12/1868; H04L 12/1881; H04W 12/08

(57) ABSTRACT

An indication method for a status variable of a multicast service includes a transmitting side sends PDCP COUNT information to a receiving side. The PDCP COUNT information includes at least a PDCP COUNT value, a PDCP HFN value, or an SN value.

### CROSS-REFERENCE TO RELATED APPLICATIONS

The present application is a Bypass Continuation application of International Patent Application No. PCT/CN2022/119245, filed Sep. 16, 2022, and claims priority to Chinese Patent Application No. 202111102087.X, filed Sep. 18, 2021, the disclosures of which are hereby incorporated by reference in their entireties.

### BACKGROUND OF THE INVENTION

### Field of the Invention

This application pertains to the field of communication technologies, and to an indication method for a status variable of a multicast service and a device.

### Description of Related Art

In a conventional technology, both a user to network universal interface (Uu) and a sidelink (SL) interface enable a security mechanism at a packet data convergence protocol (PDCP) layer only for unicast transmission. For both Uu multicast and SL multicast/broadcast services, the security mechanism at the PDCP layer is not enabled, and multicast transmission has relatively low security.

### SUMMARY OF THE INVENTION

Embodiments of this application provide an indication method for a status variable of a multicast service and a device.

According to a first aspect, an indication method for a status variable of a multicast service is provided, including: A transmitting side sends PDCP COUNT information to a receiving side, where the PDCP COUNT information includes at least one of the following: a PDCP COUNT value, a PDCP HFN value, or an SN value.

According to a second aspect, an indication method for a status variable of a multicast service is provided, including: A receiving side receives PDCP COUNT information from a transmitting side, where the PDCP COUNT information includes at least one of the following: a PDCP COUNT value, a PDCP HFN value, or an SN value.

According to a third aspect, an indication apparatus for a status variable of a multicast service is provided, including: a sending module, configured to send PDCP COUNT information to a receiving side, where the PDCP COUNT information includes at least one of the following: a PDCP COUNT value, a PDCP HFN value, or an SN value.

According to a fourth aspect, an indication apparatus for a status variable of a multicast service is provided, including: a receiving module, configured to receive PDCP COUNT information from a transmitting side, where the PDCP COUNT information includes at least one of the following: a PDCP COUNT value, a PDCP HFN value, or an SN value.

According to a fifth aspect, a terminal is provided. The terminal includes a processor, a memory, and a program or an instruction stored in the memory and executable on the processor. When the program or the instruction is executed by the processor, the method according to the first aspect or the second aspect is implemented.

According to a sixth aspect, a terminal is provided, including a processor and a communication interface. The communication interface is configured to send PDCP COUNT information to a receiving side, or receive PDCP COUNT information from a transmitting side, where the PDCP COUNT information includes at least one of the following: a PDCP COUNT value, a PDCP HFN value, or an SN value.

According to a seventh aspect, a network side device is provided. The network side device includes a processor, a memory, and a program or an instruction stored in the memory and executable on the processor. When the program or the instruction is executed by the processor, the method according to the first aspect or the second aspect is implemented.

According to an eighth aspect, a network side device is provided, including a processor and a communication interface. The communication interface is configured to send PDCP COUNT information to a receiving side, or receive PDCP COUNT information from a transmitting side, where the PDCP COUNT information includes at least one of the following: a PDCP COUNT value, a PDCP HFN value, or an SN value.

According to a ninth aspect, a non-transitory readable storage medium is provided. The non-transitory readable storage medium stores a program or an instruction. When the program or the instruction is executed by a processor, the method according to the first aspect or the second aspect is implemented.

According to a tenth aspect, a chip is provided. The chip includes a processor and a communication interface. The communication interface is coupled to the processor, and the processor is configured to run a program or an instruction, so as to implement the method according to the first aspect or the second aspect.

According to an eleventh aspect, a computer program/program product is provided. The computer program/program product is stored in a non-transitory storage medium, and the program/program product is executed by at least one processor to implement the method according to the first aspect or the second aspect.

### BRIEF DESCRIPTION OF THE DRAWINGS

The terms Fig., Figs., Figure, and Figures are used interchangeably in the specification to refer to the corresponding figures in the drawings.

FIG. 1 is a schematic diagram of a wireless communication system according to an embodiment of this application;

FIG. 2 is a schematic flowchart of an indication method for a status variable of a multicast service according to an embodiment of this application;

FIG. 3 is a schematic flowchart of an indication method for a status variable of a multicast service according to an embodiment of this application;

FIG. 4 is a schematic diagram of a structure of an indication apparatus for a status variable of a multicast service according to an embodiment of this application;

FIG. 5 is a schematic diagram of a structure of an indication apparatus for a status variable of a multicast service according to an embodiment of this application;

FIG. 6 is a schematic diagram of a structure of a communication device according to an embodiment of this application;

FIG. 7 is a schematic diagram of a structure of a terminal according to an embodiment of this application; and

FIG. 8 is a schematic diagram of a structure of a network side device according to an embodiment of this application.

### DESCRIPTION OF THE INVENTION

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that the technology described in the embodiments of this application is not limited to a Long Term Evolution (LTE)/LTE-advanced (LTE-A) system, and may also be used in various wireless communication systems, for example, Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th generation (6G) communication system.

FIG. 1 is a schematic diagram of a wireless communication system to which an embodiment of this application can be applied. The wireless communication system includes a terminal 11 and a network side device 12. The terminal 11 may also be referred to as a terminal device or a user equipment (UE). The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), smart household (household devices with wireless communication functions, such as a refrigerator, a television, a washing machine, or furniture), and the wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, a game console, and the like. It should be noted that a specific type of the terminal 11 is not limited in the embodiments of this application. The network side device 12 may be a base station or a core network. The base station may be referred to as a NodeB, an evolved NodeB, an access point, a base transceiver station (BTS), a radio base station, a radio transceiver, a basic service set (BSS), an extended service set (ESS), a NodeB, an evolved NodeB (eNB), a next generation NodeB (gNB), a home NodeB, a home evolved NodeB, a WLAN access point, a Wi-Fi node, a transmission and reception point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

With reference to the accompanying drawings, an indication method for a status variable of a multicast service and a device that are provided in the embodiments of this application is described by using some embodiments and application scenarios thereof.

The embodiments of this application mainly include the following content.
(1) A transmitting side sends packet data convergence protocol (PPDCP) count (COUNT) information to a receiving side through a signaling process. The transmitting side may be a network side device or a terminal, and the receiving side is generally a terminal. The signaling process may be a Uu radio resource control (RRC) process or a sidelink RRC process. After the PDCP COUNT information is received, the receiving side obtains a PDCP COUNT value, to assign a value to or update a status variable of the receiving side, and may also reply a completion message to the transmitting side to end the signaling process.
(2) The transmitting side carries the PDCP COUNT information by using a data packet. Because a common data packet carries only a PDCP SN value, an additional indication field may be set in a header of the data packet, indicating whether the PDCP SN value or the PDCP COUNT information is carried in the data packet, so that the receiving side parses the header based on a specified data packet format. After the PDCP COUNT value is obtained, the receiving side assigns a value to or updates the status variable of the receiving side by using the PDCP COUNT value.
(3) The transmitting side carries the PDCP COUNT information through a control protocol data unit (PDU) process. After the PDCP COUNT information is received, the receiving side obtains the PDCP COUNT value, so as to assign a value to or update the status variable of the receiving side.

The foregoing sending of the COUNT information may be performed when the multicast service is established, to initialize a receive status variable; may be performed in a transmission process of multicast data, to update and synchronize the PDCP COUNT value of the data packet; or may be performed based on a request or report of the receiving side. For example, the receiving side may actively request to perform a COUNT synchronization process, or the receiving side reports a security error, such as integrity verification failure.

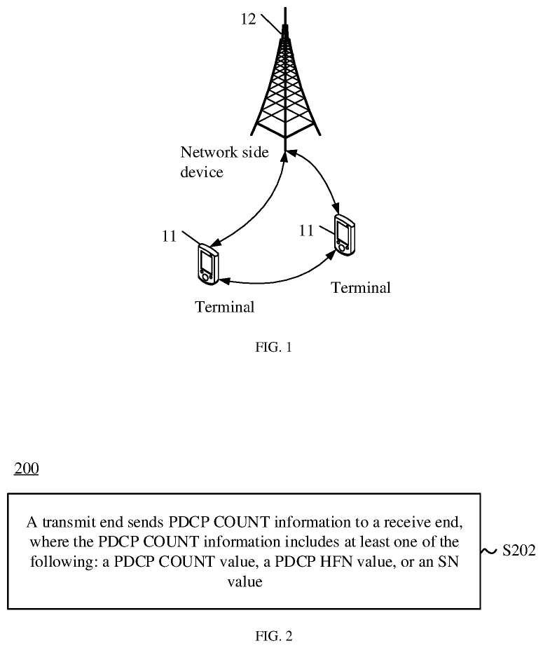

As shown in FIG. 2, an embodiment of this application provides an indication method 200 for a status variable of a multicast service. The method may be performed by the transmitting side. In other words, the method may be performed by software or hardware installed in the transmitting side. The method includes the following steps.

S202: The transmitting side sends the PDCP COUNT information to the receiving side, where the PDCP COUNT information includes at least one of the following: a PDCP COUNT value, a PDCP hyper frame number (HFN) value, or a sequence number (SN) value.

The transmitting side mentioned in the embodiments of this application may be a network side device, and correspondingly, the receiving side may be a terminal. This example is applicable to multicast service transmission on a Uu interface. Alternatively, both the transmitting side and the receiving side mentioned in the embodiments of this application are terminals. This example is applicable to multicast/broadcast service transmission on a sidelink interface, and multicast and broadcast may be collectively referred to as multicast.

The PDCP COUNT information is used by the receiving side to obtain the PDCP COUNT value, so as to perform decryption, integrity verification, ordering, or the like on a data packet of the multicast service. The PDCP COUNT value may be 32 bits, and may be divided into two parts. A low bit is the PDCP SN value, and a high bit is the PDCP HFN value. The PDCP SN value is generally 12 bits or 18 bits, and the PDCP HFN value is corresponding to the remaining 20 bits or 14 bits.

In this embodiment, after the PDCP COUNT value is obtained, the receiving side may further perform decryption, integrity verification, ordering, or the like on the data packet of the multicast service. Correspondingly, before sending the data packet, the transmitting side may further perform encryption, ordering, or the like on the data packet of the multicast service by using the PDCP COUNT value, so as to improve security of the multicast service.

In this embodiment, that the transmitting side sends the PDCP COUNT information to the receiving side may include at least one of the following: (1) The transmitting side sends the PDCP COUNT information to the receiving side when the multicast service is established; (2) the transmitting side sends the PDCP COUNT information to the receiving side in a transmission process of multicast data; or (3) the transmitting side sends the PDCP COUNT information to the receiving side based on feedback information of the receiving side. For example, the receiving side finds that security processing of the receiving side is faulty, for example, the integrity verification fails. Alternatively, the receiving side reports or requests the PDCP COUNT information based on a specific quantity of data packets/timer triggering, or the like.

According to the indication method for the status variable of the multicast service provided in the embodiments of this application, the transmitting side sends the PDCP COUNT information to the receiving side, where the PDCP COUNT information includes at least one of the following: the PDCP COUNT value, the PDCP HFN value, or the SN value. In this way, the receiving side may obtain the PDCP COUNT value based on the PDCP COUNT information, so as to perform decryption, integrity verification, ordering, or the like on the data packet of the multicast service, thereby improving transmission security of the multicast service.

In addition, the transmitting side may flexibly send the PDCP COUNT information based on a requirement, so that it is ensured that both the transmitting side and the receiving side are consistent with each other in understanding the COUNT. In this way, a security operation, an ordering operation, and the like can be smoothly performed, so that reception performance is improved based on resource efficiency, and poor reception experience caused by an out-of-synchronization COUNT is avoided.

Optionally, that the transmitting side sends the PDCP COUNT information to the receiving side mentioned in the embodiments of this application includes at least one of the following (1) to (3).
(1) The transmitting side sends first signaling to the receiving side, where the first signaling includes the PDCP COUNT information, and the first signaling includes, for example, radio resource control (RRC) signaling.
(2) The transmitting side sends a first data packet to the receiving side, where the first data packet includes the PDCP COUNT information. In this example, the PDCP COUNT information is carried in the data packet. For example, each time the transmitting side sends M ordinary data packets that do not carry the PDCP COUNT information, the transmitting side sends N first data packets that carry the PDCP COUNT information, where M and N are positive integers.
(3) The transmitting side sends a control protocol data unit (PDU) to the receiving side, where the control PDU includes the PDCP COUNT information. The control PDU may be a newly defined control PDU type and is used to carry the PDCP COUNT information.

The following describes in detail some implementation details of the foregoing (1) to (3) by using a plurality of examples.

In one example, in a case that the transmitting side sends the first signaling or the control PDU to the receiving side, the PDCP COUNT information may include at least one of the following: (1) PDCP COUNT information corresponding to a next to-be-sent data packet by the transmitting side; (2) PDCP COUNT information corresponding to a latest sent data packet by the transmitting side; (3) PDCP COUNT information corresponding to a data packet that has been sent by the transmitting side, where the data packet that has been sent does not include a latest sent data packet; or (4) PDCP COUNT information corresponding to a future to-be-sent data packet by the transmitting side, where the future to-be-sent data packet does not include a next to-be-sent data packet.

In one example, that the transmitting side sends the first data packet to the receiving side includes at least one of the following (1) to (4).
(1) The transmitting side sends N first data packets in a case that a new receiving side is determined to join multicast service reception, where N is a positive integer.
(2) The transmitting side sends N first data packets based on a quantity of data packets that have been sent. For example, each time the transmitting side sends M ordinary data packets that do not carry the PDCP COUNT information, the transmitting side sends N first data packets that carry the PDCP COUNT information, where M and N are positive integers.
(3) The transmitting side sends N first data packets based on a running status of a timer. For example, when the timer expires, the transmitting side sends the N first data packets, and restarts the timer after the N first data packets are sent. A common data packet that does not carry the PDCP COUNT information may be sent during running of the timer. N is a positive integer.
(4) The transmitting side sends N first data packets based on the feedback information of the receiving side. For example, the receiving side finds that security processing of the receiving side is faulty, for example, the integrity verification fails. Alternatively, the receiving side reports or requests the PDCP COUNT information based on a specific quantity of data packets/timer triggering, or the like. N is a positive integer.

In one example, that the transmitting side sends the control PDU to the receiving side includes at least one of the following: (1) The transmitting side sends one control PDU in a case that a new receiving side is determined to join multicast service reception; (2) the transmitting side sends one control PDU based on a quantity of data packets that have been sent; (3) the transmitting side sends one control PDU based on a running status of a timer; or (4) the transmitting side sends one control PDU based on the feedback information of the receiving side. For implementation details of this example, refer to the descriptions of the previous example.

In one example, when the transmitting side sends the first data packet or the control PDU to the receiving side, that the transmitting side sends the PDCP COUNT information to the receiving side includes at least one of the following (1) or (2).
(1) The transmitting side sends the PDCP COUNT information to the receiving side on a point-to-multipoint (PTM) transmission leg. In this example, a plurality of receiving sides may receive the PDCP COUNT information.
(2) The transmitting side sends the PDCP COUNT information to the receiving side on a point-to-point (PTP) transmission leg. This example may not affect users who normally perform reception, and may instruct a small quantity of newly joined receiving sides to perform an initialization operation, or perform an update operation on an individually requested or reported receiving side, thereby avoiding impact on another receiving side.

In one example, that the transmitting side sends the control PDU to the receiving side includes at least one of the following:
(1) When a radio link control (RLC) layer of the transmitting side is configured as an acknowledged mode (AM), the transmitting side sends one control PDU to the receiving side.
(2) When an RLC layer of the transmitting side is configured as an unacknowledged mode (UM), the transmitting side sends the control PDU to the receiving side based on hybrid automatic repeat request HARQ feedback information at a medium access control (MAC) layer, where the HARQ feedback information at the MAC layer indicates whether the control PDU is correctly received by the receiving side.

Optionally, in a case that it is determined, based on the HARQ feedback information at the MAC layer, that the control PDU is not correctly received by the receiving side, the transmitting side re-sends the control PDU to the receiving side; or re-generates a control PDU and sends the re-generated control PDU to the receiving side.
(3) The transmitting side sends a plurality of control PDUs or the control PDU for a plurality of times to the receiving side. In this example, a PDCP layer of the transmitting side may determine to send the plurality of control PDUs or the control PDU for the plurality of times, to improve reliability.

In one example, the first data packet includes indication information for a packet format, the indication information for the packet format indicates a data packet format, and the data packet format includes a format of the first data packet that carries the PDCP COUNT information or a format of a data packet that carries only an SN value. Certainly, the indication information for the packet format in this embodiment indicates the format of the first data packet that carries the PDCP COUNT information.

In one example, the first data packet includes indication information for a PDU type, the indication information for the PDU type indicates a data packet format, and the data packet format includes a format of the first data packet that carries the PDCP COUNT information or a format of a data packet that carries only an SN value. Certainly, the indication information for the PDU type in this embodiment indicates the format of the first data packet that carries the PDCP COUNT information.

In one example, the first data packet includes first indication information and a PDCP SN value, and the first indication information indicates whether the PDCP COUNT information exists. Certainly, the first indication information in this embodiment indicates that the PDCP COUNT information is carried.

In one example, the control PDU includes type indication information, and the type indication information indicates a type of the control PDU. The type of the control PDU includes one of the following: (1) a type of the control PDU including the PDCP COUNT information; (2) a type of a PDCP status report, a type of robust header compression (ROHC) feedback, and a type of ethernet header compression (EHC) feedback. Certainly, the type indication information in this embodiment indicates the type of the control PDU including the PDCP COUNT information in (1).

To describe indication for the status variable of the multicast service provided in the embodiments of this application, the following provides descriptions with reference to several embodiments. In Embodiment 1, the transmitting side mainly carries the PDCP COUNT information by using the first signaling. In Embodiment 2, the transmitting side carries the PDCP COUNT information by using the first data packet. In Embodiment 3, the transmitting side carries the PDCP COUNT information by using the control PDU.

### Embodiment 1

This embodiment describes a method in which a transmitting side sends L2 status variable information to a receiving side through a signaling process. The signaling process is generally an RRC process, and may be a dedicated RRC process, or may be a multicast or broadcast RRC process. In this embodiment, a dedicated RRC process in which a base station sends the L2 status variable information to a UE is used as an example to describe an overall working procedure.

In receiving a Uu multicast service, the UE is generally required to enter a connected state for receiving the service. After the UE enters the connected state, the UE may actively report information about a multicast service of interest to the UE. Alternatively, a network side obtains a UE list of multicast services of interest from a core network, and may determine, by accessing a used UE identifier by using the UE, that the UE is interested in the multicast service in the list.

The network side sends, to the UE by using dedicated signaling, configuration information corresponding to the multicast service, for example, a group-radio network temporary identity (G-RNTI), an multicast radio bearer (MRB) configuration, an L2/L1 configuration, and a discontinuous reception (DRX) configuration. Herein, for all or a part of MRBs of the multicast service, PDCP COUNT information corresponding to each MRB may be carried. Each MRB is corresponding to one PDCP entity, and a COUNT value of each PDCP entity is independent. Therefore, for each MRB whose COUNT value needs to be sent, the following information or combination may be available:
(1) a COUNT value corresponding to a next to-be-sent data packet by the transmitting side;
(2) an HFN value and an SN value corresponding to a next to-be-sent data packet by the transmitting side;
(3) a next to-be-sent HFN value by the transmitting side;
(4) a COUNT value corresponding to a latest sent data packet by the transmitting side;
(5) an HFN value and an SN value corresponding to a latest sent data packet by the transmitting side;
(6) an HFN value corresponding to a latest sent data packet by the transmitting side;
(7) a COUNT value corresponding to a data packet that has been sent or a future to-be-sent data packet by the transmitting side;
(8) an HFN value and an SN value corresponding to a data packet that has been sent or a future to-be-sent data packet by the transmitting side; or
(9) an HFN value corresponding to a data packet that has been sent or a future to-be-sent data packet by the transmitting side.

The network side sends the configuration information and the PDCP COUNT information to the UE through the dedicated RRC process. After receiving the configuration information and the PDCP COUNT information, the UE establishes a corresponding MRB and L2 entity based on the configuration information, and performs an initialization operation on a receive variable based on PDCP COUNT information of each MRB.

When the PDCP COUNT value is directly received, the UE directly initializes a status variable of the receiving side by using the PDCP COUNT value, for example:
(1) initializing a next expected to-be-received variable RX_NEXT to COUNT+1;
(2) initializing a next expected to-be-received variable RX_NEXT to COUNT;
(3) initializing a first variable that is still waiting for reordering and that is not delivered to a higher layer RX_DELIV to COUNT-0.5×the receive window, where when a result of the subtraction is less than 0, RX_DELIV is directly equal to 0;
(4) initializing a first variable that is still waiting for reordering and that is not delivered to a higher layer RX_DELIV to COUNT+1; or
(5) initializing a first variable that is still waiting for reordering and that is not delivered to a higher layer RX_DELIV to COUNT.

When HFN+SN information is received, the foregoing two values are combined into a COUNT value by respectively using one value as a high bit and the other value as a low bit, and a process similar to that of receiving the COUNT is performed.

When the HFN value is received, a received SN value is needed to update a variable. The received SN value may be an SN value carried in a first data packet received at a PDCP layer of the MRB. The SN value and the HFN value are respectively used as a low bit and a high bit that are of the COUNT value to form a complete COUNT value, and then the foregoing initialization process is performed.

After the UE is configured, a completion message may be returned to the network side. The receiving side UE performs subsequent receiving and data packet processing by using a current receive variable.

The foregoing provides a typical process in which signaling notifies COUNT initialization information to establish an initial value of an initial receive variable for the receiving side. Similarly, the foregoing process in which the signaling notifies the COUNT information may also be used in a process of sending a data packet. The transmitting side actively performing COUNT information notification, which is generally based on a specific quantity of data packets or based on a timer. Alternatively, the transmitting side performs sending based on a request of the receiving side. The receiving side may request or report based on a receiving status, a synchronization status of a COUNT value, or a status of security processing of the receiving side. For example, the receiving side finds that the receiving side receives N data packets that exceed a receive window, or the receiving side finds security processing of the receiving side is faulty, for example, integrity verification fails. Alternatively, the receiving side reports or requests based on a specific quantity of data packets/timer triggering, or the like.

In a process of sending data, content of the COUNT information sent by the transmitting side by using RRC signaling is still one or a combination of the foregoing various cases. After the COUNT information is received, processing of the receiving side is different from the initialization process. Because a receive status variable and a receive window are established at this time at the receiving side, there are mainly two major operation manners after the COUNT information is received.

In a first manner, all received information and windows of the receiving side and a cache are reset. Optionally, all existing receive variables are reset, cached data is cleared, and a reordering timer is deleted. Then, a new receive status variable and window are re-established as initialized based on the received COUNT information, and data is continued to be received. A manner for re-establishment is the same as that of the foregoing initialization processing by the receiving side.

In a second manner, the receive status variable information and the window of the receiving side are correspondingly updated, and the cached data is reserved. Optionally, the received COUNT information (whether it is a direct COUNT value or an HFN value and an SN value that can be combined into a COUNT value) is used as newly received data, on which receive processing is performed.

When the newly received COUNT value is less than RX_DELIV, it indicates that the data has been reordered or submitted to the higher layer.

When the newly received COUNT value is greater than or equal to RX_DELIV and is less than RX_NEXT, it indicates that the data is waiting for reordering or is not submitted to the higher layer.

When the newly received COUNT value is greater than or equal to RX_NEXT, it indicates that the data is still not received, or the HFN is out of synchronization. In this case, the receive variable needs to be updated accordingly: (1) updating RX NEXT to COUNT+1; (2) after the update, when a difference between RX_NEXT and RX_DELIV is greater than a window size, it indicates that the HFN is out of synchronization, and in this case, updating RX_DELIV=COUNT-0.5×the window size, or RX_DELIV=COUNT or COUNT+1; clearing all data packets smaller than RX_DELIV in the cache; reserving data packets between RX_DELIV and RX_NEXT; and optionally, starting the reordering timer when the foregoing two variables are not equal.

When the foregoing HFN out of synchronization does not occur, the RX_DELIV and the cache do not need to be updated, and subsequent packet receiving processing is performed.

The signaling process generally has a complete response. After the update processing is completed, the receiving side feeds back the completion message to the transmitting side. Optionally, when the HFN is out of synchronization, the receiving side may further explicitly indicate that the HFN is out of synchronization or provide information about the out of synchronization of the HFN, such as an indication of whether a 1 bit HFN is out of synchronization or a value of a difference between an HFN maintained by the receiving side and an HFN updated by the transmitting side (a calculation manner may be, for example, subtracting a value of an HFN portion of an original RX_DELIV variable of the receiving side from an HFN value of a COUNT value carried in signaling).

### Embodiment 2

This embodiment provides a manner in which COUNT information is directly carried by data, to achieve initialization or update of a COUNT value.

In a conventional technology, a header of a PDCP data packet carries an SN field, which is only 12 bits or 18 bits, a length of a statically configurable SN field. To carry COUNT information in the PDCP data packet, there may be the following several data packet formats.

In a first manner, a 1 bit indication field for packet format is introduced. For example, when a value of this field is 0, it represents a traditional data packet format that carries only an SN field. When a value of this field is 1, it represents a new data packet format that carries a COUNT field. Then, the receiving side may, based on the indication field, parse out the SN field or the COUNT field based on a correct data packet format. When the SN field is parsed, traditional processing is performed. When the COUNT field is parsed, a new operation procedure for initialization or update is performed.

In a second manner, a PDU type field of 3 bits or another length is introduced. When one of values of a PDU type is, for example, 001, it may represent a traditional data packet format that carries only an SN field. When another value of the PDU type is, for example, 010, it may represent a new data packet format that carries a COUNT field. Then, the receiving side may, based on the indication field, parse out the SN field or the COUNT field based on a correct data packet format. When the SN field is parsed, traditional processing is performed. When the COUNT field is parsed, a new operation procedure for initialization or update is performed.

In both the foregoing two manners, the SN field and the COUNT field are distinguished. In a third manner, the SN field may be invariably carried, and an indication similar to that in the foregoing two manners is used to indicate whether the HFN field appears. When it is indicated that the HFN field does not appear, the SN field is obtained by reading a header format. When it is indicated that the HFN field appears, both the SN field and the HFN field are obtained by reading a header format to form a COUNT value. Therefore, the COUNT value may also be obtained, and a new operation procedure for initialization or update may be triggered.

Generally, the transmitting side may have the COUNT information carried on the data packet in the following cases.
(1) When it is clearly learned that a new receiving side UE just joins multicast reception, the transmitting side sends N data packets that carry COUNT values, to help the newly joined UE establish initialization of a receive status variable.
(2) The transmitting side sends, based on a quantity of to-be-sent data packets, for example, N data packets that carry COUNT values each time the transmitting side sends M data packets, to support an existing UE to update a receive status variable, and help a newly joined UE in this section establish initialization of the receive status variable.
(3) The transmitting side sends, based on a timer, for example, a periodic timer that is started, N data packets that carry COUNT values each time the timer expires, to support an existing UE to update a receive status variable, and help a newly joined UE in this section establish initialization of the receive status variable.
(4) The transmitting side may alternatively determine, based on triggering of the receiving side, for example, the receiving side requests the COUNT value, or the receiving side reports a security operation exception/failure, to send N data packets that carry COUNT values, to help request a UE to update a receive status variable, and help a newly joined UE establish initialization of the receive status variable.

Generally, the N data packets that carry the COUNT information may be N continuous data packets or N discontinuous data packets with a specific interval that are selected by the transmitting side from to-be-sent data packets. In a special case, the transmitting side may alternatively retransmit data that has been sent, to carry the COUNT information.

A receiving behavior of the receiving side is as follows.

For a new UE that joins multicast reception, a PDCP layer entity of the UE is in a newly-established state. In this case, for a received data packet that carries the COUNT value, an initialization operation is performed on a receive status variable and a window. For operation details, refer to the initialization operation in Embodiment 1. At the same time, normal receiving processing is also performed on the received data packet, for example, determining whether to receive the data packet in sequence, whether to start a reordering timer, and whether to deliver to a higher layer.

For a UE that has been normally performing multicast reception, a PDCP layer entity of the UE has been maintained by a current receive status variable and window. In this case, when an additional data packet that carries the COUNT value is received, an update operation is performed on an initialized receive status variable and window. For operation details, refer to the initialization operation or the update operation in Embodiment 1. At the same time, normal receiving processing is also performed on the received data packet, for example, determining whether to repeatedly delete the received data packet, whether to receive the data packet in sequence, whether to start a reordering timer, and whether to deliver to a higher layer.

In particular, when it is expected that the data packet that carries the COUNT information works for all multicast users, the data packet may be sent on a common PTM leg, and all UEs receive and update the data packet.

When it is not intended to affect users who normally perform reception, and an initialization operation needs to be performed on a few newly added UEs, or an individual receive UE that requests or reports needs to be updated, a dedicated PTP leg of the UE may alternatively be used for transmission. In this way, only these UEs perform reception and an initialization or update operation, thereby avoiding impact on other UEs.

### Embodiment 3

This embodiment describes a method in which COUNT information is carried by using an L2 control PDU, to help a receiving side establish receive status initialization or update a receive status.

There are three types of existing PDCP control PDUs: a PDCP status report, ROHC feedback, and EHC feedback. In this embodiment, a fourth type, that is, PDCP COUNT information, may be added. Correspondingly, a new value of a PDU type field may be used to indicate this type of control PDU. In addition to the type indication, the control PDU may carry a COUNT value of 32 bits. For a setting manner of the COUNT value, refer to setting of the COUNT value carried in the signaling in Embodiment 1.

When the receiving side is a new UE that joins multicast reception, a PDCP receiving side variable of the UE does not have an initial value, a receive status variable is initialized based on a COUNT value in a received control PDU. For an initialization manner, refer to the initialization manner in Embodiment 1. When the receiving side is a UE that has been performing reception, a PDCP receiving side of the UE is already maintained by a status variable. A COUNT value in a received control PDU may be reset, and then an initialization or update operation may be performed. For a related operation manner, refer to the two manners in Embodiment 1.

Generally, the transmitting side may have the COUNT value carried on the control PDU in the following cases.
(1) When it is clearly learned that a new receiving side UE just joins multicast reception, the transmitting side sends one control PDU that carries the COUNT value, to help the newly joined UE establish initialization of a receive status variable.
(2) The transmitting side sends, based on a quantity of to-be-sent data packets, for example, one control PDU that carries the COUNT value each time the transmitting side sends M data packets, to support an existing UE to update a receive status variable, and help a newly joined UE in this section establish initialization of the receive status variable.
(3) The transmitting side sends, based on a timer, for example, a periodic timer that is started, one control PDU that carries the COUNT value each time the timer expires, to support an existing UE to update a receive status variable, and help a newly joined UE in this section establish initialization of the receive status variable.
(4) The transmitting side may alternatively determine, based on triggering of the receiving side, for example, the receiving side requests the COUNT value, or the receiving side reports a security operation exception/failure, to send one control PDU that carries the COUNT value, to help request a UE to update a receive status variable, and help a newly joined UE establish initialization of the receive status variable.

In particular, when it is expected that the control PDU that carries the COUNT value works for all multicast users, the control PDU may be sent on a common PTM leg, and all UEs receive and update the control PDU.

When it is not intended to affect users who normally perform reception, and an initialization operation needs to be performed on a few newly added UEs, or an individual receive UE that requests or reports needs to be updated, a dedicated PTP leg of the UE may alternatively be used for transmission. In this way, only these UEs perform reception and an initialization or update operation, thereby avoiding impact on other UEs.

Generally, one control PDU can be sent at a time, and transmission reliability is ensured by an underlying layer such as an RLC layer or an MAC layer. For example, when the underlying layer is the RLC layer, and the RLC layer is configured as an AM (usually only a PTP leg can be configured as the AM), it is sufficient to send one control PDU because the AM does not allow de-packet.

When the RLC layer is configured as an UM, MAC HARQ feedback can be relied on to track whether the control PDU is received correctly. When the control PDU is not received correctly, the control PDU is retransmitted or the control PDU is reorganized for transmission based on a latest status.

Alternatively, when there is no underlying layer that tracks whether the control PDU is received correctly, the PDCP layer determines to send a plurality of control PDUs or the control PDU for a plurality of times, to improve reliability.

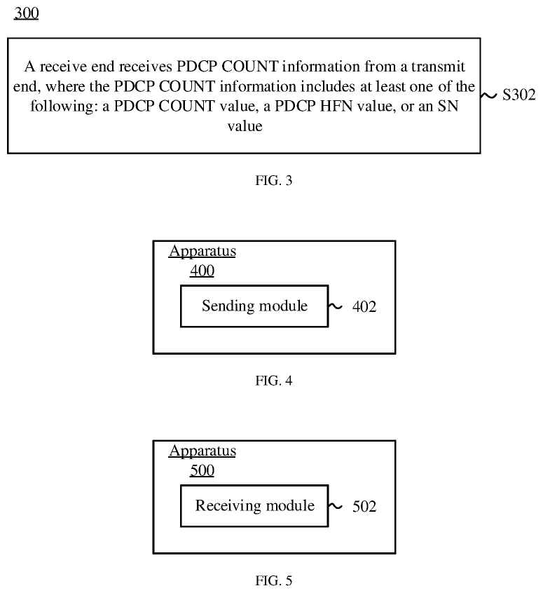

The foregoing describes an indication method for a status variable of a multicast service according to an embodiment of this application with reference to FIG. 2. The following will describe an indication method for a status variable of a multicast service according to another embodiment of this application with reference to FIG. 3. It may be understood that descriptions on the receiving side is the same as those on the transmitting side in the method shown in FIG. 2. To avoid repetition, related descriptions are appropriately omitted.

FIG. 3 is a schematic flowchart for implementing an indication method for a status variable of a multicast service according to an embodiment of this application, and the method may be applied to a receiving side. As shown in FIG. 3, the method 300 includes the following steps.

S302: The receiving side receives PDCP COUNT information from a transmitting side, where the PDCP COUNT information includes at least one of the following: a PDCP COUNT value, a PDCP HFN value, or an SN value.

According to the indication method for the status variable of the multicast service provided in the embodiments of this application, the receiving side receives the PDCP COUNT information from the transmitting side, where the PDCP COUNT information includes at least one of the following: the PDCP COUNT value, the PDCP HFN value, or the SN value. In this way, the receiving side may obtain the PDCP COUNT value based on the PDCP COUNT information, so as to perform decryption, integrity verification, ordering, or the like on the data packet of the multicast service, thereby improving transmission security of the multicast service.

Optionally, in an embodiment, after the receiving side receives the PDCP COUNT information from the transmitting side, the method further includes one of the following: (1) The receiving side obtains a PDCP COUNT value based on the PDCP COUNT information, and initializes a status variable by using the PDCP COUNT value; or (2) the receiving side obtains a PDCP COUNT value based on the PDCP COUNT information, and updates a status variable and a receive window by using the PDCP COUNT value.

Optionally, in an embodiment, that the receiving side initializes a status variable by using the PDCP COUNT value includes at least one of the following: (1) initializing RX_NEXT to the PDCP COUNT value plus 1; (2) initializing RX_NEXT to the PDCP COUNT value; (3) initializing RX_DELIV to the PDCP COUNT value minus 0.5×the receive window, where when a result of the PDCP COUNT value minus 0.5×the receive window is less than 0, RX_DELIV is equal to 0; (4) initializing RX_DELIV to the PDCP COUNT value plus 1; or (5) initializing RX_DELIV to the PDCP COUNT value. RX_NEXT represents a next expected to-be-received variable by the receiving side, and RX_DELIV represents a first variable that is in a receive window of the receiving side and that is still waiting for reordering and not delivered to a higher layer.

Optionally, in an embodiment, the PDCP COUNT information is received in a transmission process of multicast data, and before the receiving side initializes a status variable by using the PDCP COUNT value, the method further includes at least one of the following: the receiving side resets the status variable; clears cached data; or deletes a reordering timer.

Optionally, in an embodiment, that the receiving side updates a status variable by using the PDCP COUNT value includes: updating RX_NEXT to the PDCP COUNT value plus 1; or when a difference between updated RX_NEXT and RX_DELIV is greater than the receive window, updating RX_DELIV to the PDCP COUNT value minus 0.5×the receive window; updating RX_DELIV to the PDCP COUNT value; or updating RX_DELIV to the PDCP COUNT value plus 1. RX_NEXT represents a next expected to-be-received variable by the receiving side, and RX_DELIV represents a first variable that is in a receive window of the receiving side and that is still waiting for reordering and not delivered to a higher layer.

Optionally, in an embodiment, the method further includes at least one of the following: (1) clearing a data packet smaller than RX_DELIV in a cache, and reserving a data packet between RX_DELIV and RX_NEXT; (2) delivering a data packet smaller than RX_DELIV in a cache to the higher layer in sequence, where “in sequence” mentioned herein may be an order of ascending PDCP COUNT values of the data packet; or (3) when RX_DELIV and RX_NEXT are not equal, starting a reordering timer.

It should be noted that the indication method for the status variable of the multicast service provided by the embodiments of this application may be performed by an indication apparatus for the status variable of the multicast service, or a control module in the indication apparatus for the status variable of the multicast service configured to execute the indication method for the status variable of the multicast service. In the embodiments of this application, the indication method for the status variable of the multicast service being performed by the indication apparatus for the status variable of the multicast service is used as an example to illustrate the indication apparatus for the status variable of the multicast service provided by the embodiments of this application.

FIG. 4 is a schematic diagram of a structure of an indication apparatus for a status variable of a multicast service according to an embodiment of this application, and the apparatus may be corresponding to a transmitting side in another embodiment. As shown in FIG. 4, an apparatus 400 includes the following module:
a sending module 402, configured to send PDCP COUNT information to a receiving side, where the PDCP COUNT information includes at least one of the following: a PDCP COUNT value, a PDCP HFN value, or an SN value.

Optionally, the apparatus 400 further includes a processing module.

According to the indication apparatus for the status variable of the multicast service provided in the embodiments of this application, the sending module sends the PDCP COUNT information to the receiving side, where the PDCP COUNT information includes at least one of the following: the PDCP COUNT value, the PDCP HFN value, or the SN value. In this way, the receiving side may obtain the PDCP COUNT value based on the PDCP COUNT information, so as to perform decryption, integrity verification, ordering, or the like on a data packet of the multicast service, thereby improving transmission security of the multicast service.

Optionally, in an embodiment, the sending module 402 is configured to perform at least one of the following: sending the PDCP COUNT information to the receiving side when the multicast service is established; sending the PDCP COUNT information to the receiving side in a transmission process of multicast data; or sending the PDCP COUNT information to the receiving side based on feedback information of the receiving side.

Optionally, in an embodiment, the apparatus is a network side device, and the receiving side is a terminal; or both the apparatus and the receiving side are terminals.

Optionally, in an embodiment, the sending module 402 is configured to perform at least one of the following: sending first signaling to the receiving side, where the first signaling includes the PDCP COUNT information; sending a first data packet to the receiving side, where the first data packet includes the PDCP COUNT information; or sending a control PDU to the receiving side, where the control PDU includes the PDCP COUNT information.

Optionally, in an embodiment, in a case that the transmitting side sends the first signaling or the control PDU to the receiving side, the PDCP COUNT information may include at least one of the following: (1) PDCP COUNT information corresponding to a next to-be-sent data packet; (2) PDCP COUNT information corresponding to a latest sent data packet; (3) PDCP COUNT information corresponding to a data packet that has been sent, where the data packet that has been sent does not include a latest sent data packet; or (4) PDCP COUNT information corresponding to a future to-be-sent data packet, where the future to-be-sent data packet does not include a next to-be-sent data packet.

Optionally, in an embodiment, the sending module 402 is configured to perform at least one of the following: (1) sending N first data packets in a case that a new receiving side is determined to join multicast service reception; (2) sending N first data packets based on a quantity of data packets that have been sent; (3) sending N first data packets based on a running status of a timer; or (4) sending N first data packets based on the feedback information of the receiving side. N is a positive integer.

Optionally, in an embodiment, the sending module 402 is configured to perform at least one of the following: (1) sending one control PDU in a case that a new receiving side is determined to join multicast service reception; (2) sending one control PDU based on a quantity of data packets that have been sent; (3) sending one control PDU based on a running status of a timer; or (4) sending one control PDU based on the feedback information of the receiving side.

Optionally, in an embodiment, when the first data packet or the control PDU is sent to the receiving side, the sending module 402 is configured to perform at least one of the following: (1) sending the PDCP COUNT information to the receiving side on a point-to-multipoint PTM transmission leg; or (2) sending the PDCP COUNT information to the receiving side on a point-to-point PTP transmission leg.

Optionally, in an embodiment, the sending module 402 is configured to perform at least one of the following: (1) when a radio link control RLC layer of the apparatus is configured as an acknowledged mode AM, sending one control PDU to the receiving side; (2) when an RLC layer of the transmitting side is configured as an unacknowledged mode UM, sending the control PDU to the receiving side based on hybrid automatic repeat request HARQ feedback information at a medium access control MAC layer, where the HARQ feedback information at the MAC layer indicates whether the control PDU is correctly received by the receiving side; or (3) sending a plurality of control PDUs or the control PDU for a plurality of times to the receiving side.

Optionally, in an embodiment, the sending module 402 is configured to, in a case that it is determined, based on the HARQ feedback information at the MAC layer, that the control PDU is not correctly received by the receiving side, re-send the control PDU to the receiving side; or re-generate a control PDU and send the re-generated control PDU to the receiving side.

Optionally, in an embodiment, the first data packet includes indication information for a packet format, the indication information for the packet format indicates a data packet format, and the data packet format includes a format of the first data packet that carries the PDCP COUNT information or a format of a data packet that carries only an SN value. Alternatively, the first data packet includes indication information for a PDU type, the indication information for the PDU type indicates a data packet format, and the data packet format includes a format of the first data packet that carries the PDCP COUNT information or a format of a data packet that carries only an SN value. Alternatively, the first data packet includes first indication information and a PDCP SN value, and the first indication information indicates whether the PDCP COUNT information exists.

Optionally, in an embodiment, the control PDU includes type indication information, and the type indication information indicates a type of the control PDU. The type of the control PDU includes one of the following: a type of the control PDU including the PDCP COUNT information, a type of a PDCP status report, a type of ROHC feedback, and a type of EHC feedback.

The apparatus 400 according to this embodiment of this application may correspond to the procedures of the method 200 in the embodiments of this application, and the units/modules in the apparatus 400 and the foregoing operations and/or functions are separately for implementing the corresponding procedures of the method 200, and can achieve a same or equivalent technical effect. For brevity, details are not described herein again.

The indication apparatus for the status variable of the multicast service in the embodiments of this application may be an apparatus, an apparatus or an electronic device with an operating system, or may be a component, an integrated circuit, or a chip in a terminal. The apparatus or the electronic device may be a mobile terminal, or a non-mobile terminal. For example, the mobile terminal may include but is not limited to the types of the foregoing listed terminal 11, and the non-mobile terminal may be a server, a network attached storage (NAS), a personal computer (PC), a television (TV), an automated teller machine, or a self-service machine. This is not specifically limited in the embodiments of this application.

The indication apparatus for the status variable of the multicast service provided in the embodiments of this application can implement the processes implemented in the method embodiments in FIG. 2 to FIG. 3, and achieve a same technical effect. To avoid repetition, details are not described herein again.

FIG. 5 is a schematic diagram of a structure of an indication apparatus for a status variable of a multicast service according to an embodiment of this application, and the apparatus may be corresponding to a receiving side in another embodiment. As shown in FIG. 5, an apparatus 500 includes the following module:
a receiving module 502, configured to receive PDCP COUNT information from a transmitting side, where the PDCP COUNT information includes at least one of the following: a PDCP COUNT value, a PDCP HFN value, or an SN value.

Optionally, the apparatus 500 further includes a processing module.

According to the indication apparatus for the status variable of the multicast service provided in the embodiments of this application, the receiving module receives the PDCP COUNT information from the transmitting side, where the PDCP COUNT information includes at least one of the following: the PDCP COUNT value, the PDCP HFN value, or the SN value. In this way, the processing module may obtain the PDCP COUNT value based on the PDCP COUNT information, so as to perform decryption, integrity verification, ordering, or the like on the data packet of the multicast service, thereby improving transmission security of the multicast service.

Optionally, in an embodiment, the apparatus further includes a processing module, and the processing module is configured to perform one of the following: (1) obtaining a PDCP COUNT value based on the PDCP COUNT information, and initializing a status variable by using the PDCP COUNT value; or (2) obtaining a PDCP COUNT value based on the PDCP COUNT information, and updating a status variable and a receive window by using the PDCP COUNT value.

Optionally, in an embodiment, the processing module is configured to perform one of the following: (1) initializing RX_NEXT to the PDCP COUNT value plus 1; (2) initializing RX_NEXT to the PDCP COUNT value; (3) initializing RX_DELIV to the PDCP COUNT value minus 0.5×the receive window, where when a result of the PDCP COUNT value minus 0.5×the receive window is less than 0, RX_DELIV is equal to 0; (4) initializing RX_DELIV to the PDCP COUNT value plus 1; or (5) initializing RX_DELIV to the PDCP COUNT value. RX_NEXT represents a next expected to-be-received variable by the receiving side, and RX_DELIV represents a first variable that is in a receive window of the receiving side and that is still waiting for reordering and not delivered to a higher layer.

Optionally, in an embodiment, the PDCP COUNT information is received in a transmission process of multicast data, and the processing module is further configured to perform at least one of the following: resetting the status variable; clearing cached data; or deleting a reordering timer.

Optionally, in an embodiment, the processing module is configured to: update RX_NEXT to the PDCP COUNT value plus 1; or when a difference between updated RX_NEXT and RX_DELIV is greater than the receive window, update RX_DELIV to the PDCP COUNT value minus 0.5×the receive window; updating RX_DELIV to the PDCP COUNT value; or update RX_DELIV to the PDCP COUNT value plus 1. RX_NEXT represents a next expected to-be-received variable by the receiving side, and RX_DELIV represents a first variable that is in a receive window of the receiving side and that is still waiting for reordering and not delivered to a higher layer.

Optionally, in an embodiment, the processing module is further configured to perform at least one of the following: (1) clearing a data packet smaller than RX_DELIV in a cache, and reserving a data packet between RX_DELIV and RX_NEXT; (2) delivering a data packet smaller than RX_DELIV in a cache to the higher layer in sequence; or (3) when RX_DELIV and RX_NEXT are not equal, starting a reordering timer.

The apparatus 500 according to this embodiment of this application may correspond to the procedures of the method 300 in the embodiments of this application, and the units/modules in the apparatus 500 and the foregoing operations and/or functions are separately for implementing the corresponding procedures of the method 300, and can achieve a same or equivalent technical effect. For brevity, details are not described herein again.

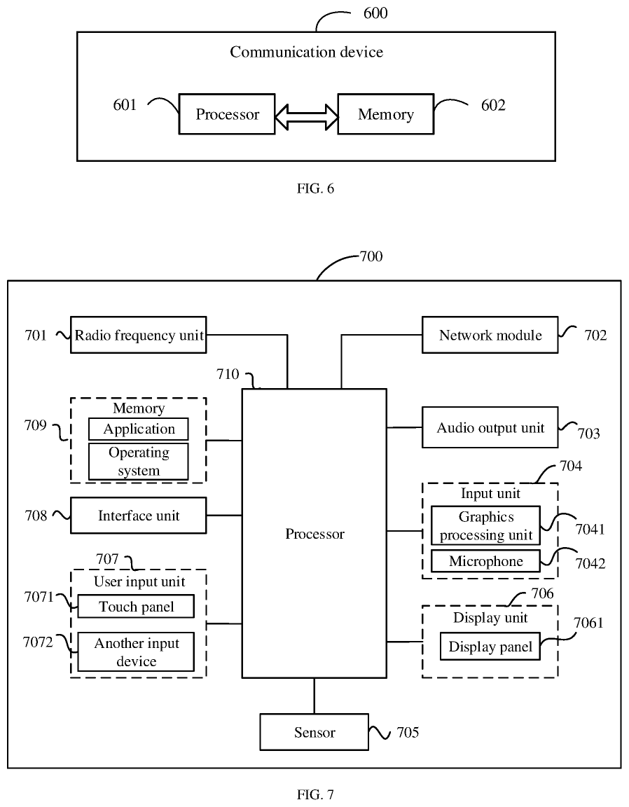

Optionally, as shown in FIG. 6, an embodiment of this application further provides a communication device 600, including a processor 601, a memory 602, and a program or an instruction stored in the memory 602 and executable on the processor 601. For example, when the communication device 600 is a terminal, when the program or the instruction is executed by the processor 601, the processes of the foregoing embodiment of the indication method for the status variable of the multicast service is implemented, and a same technical effect can be achieved. When the communication device 600 is a network side device, when the program or the instruction is executed by the processor 601, the processes of the foregoing embodiment of the indication method for the status variable of the multicast service is implemented, and a same technical effect can be achieved. To avoid repetition, details are not described herein again.

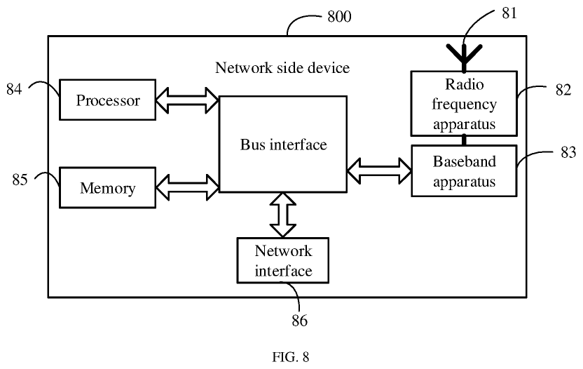

An embodiment of this application further provides a terminal, including a processor and a communication interface. The communication interface is configured to send PDCP COUNT information to a receiving side, or receive PDCP COUNT information from a transmitting side, where the PDCP COUNT information includes at least one of the following: a PDCP COUNT value, a PDCP HFN value, or an SN value. This terminal embodiment is corresponding to the foregoing method embodiment on the terminal side. Each implementation process and implementation of the foregoing method embodiment may be applicable to this terminal embodiment, and a same technical effect can be achieved. Optionally, FIG. 7 is a schematic diagram of a hardware structure of a terminal according to an embodiment of this application.

A terminal 700 includes but is not limited to some components in a radio frequency unit 701, a network module 702, an audio output unit 703, an input unit 704, a sensor 705, a display unit 706, a user input unit 707, an interface unit 708, a memory 709, and a processor 710.

It may be understood by a person skilled in the art that the terminal 700 may further include a power supply (such as a battery) that supplies power to each component. The power supply may be logically connected to the processor 710 by using a power management system, to implement functions such as charging, discharging, and power consumption management by using the power management system. The terminal structure shown in FIG. 7 constitutes no limitation on the terminal, and the terminal may include more or fewer components than those shown in the figure, or combine some components, or have different component arrangements. Details are not described herein.

It should be understood that, in this embodiment of this application, the input unit 704 may include a graphics processing unit (GPU) 7041 and a microphone 7042, and the graphics processing unit 7041 processes image data of a still picture or a video obtained by an image capture apparatus (such as a camera) in a video capture mode or an image capture mode. The display unit 706 may include a display panel 7061. Optionally, the display panel 7061 may be configured in a form such as a liquid crystal display or an organic light-emitting diode. The user input unit 707 includes a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, the radio frequency unit 701 receives downlink data from a network side device and then sends the downlink data to the processor 710 for processing; and sends uplink data to the network side device. Usually, the radio frequency unit 701 includes but is not limited to an antenna, at least one amplifier, a transceiver, a coupler, a low noise amplifier, a duplexer, and the like.

The memory 709 may be configured to store a software program or an instruction and various data. The memory 709 may mainly include a program or instruction storage area and a data storage area. The program or instruction storage area may store an operating system, an application or an instruction required by at least one function (for example, a sound playing function or an image playing function), and the like. In addition, the memory 709 may include a high-speed random access memory, and may further include a non-transitory memory. The non-transient memory may be a read-only memory (ROM), a programmable read-only memory (PROM), an erasable programmable read-only memory (EPROM), an electrically erasable programmable read-only memory (EEPROM), or a flash memory, for example, at least one disk storage device, a flash memory device, or another non-transitory solid-state storage device. In addition, the memory in this embodiment of this application may be volatile, or may be non-volatile.

The processor 710 may include one or more processing units. Optionally, an application processor and a modem processor may be integrated into the processor 710. The application processor mainly processes an operating system, a user interface, an application, an instruction, or the like. The modem processor mainly processes wireless communication, for example, a baseband processor. It may be understood that, the modem processor may alternatively not be integrated into the processor 710.

The radio frequency unit 701 may be configured to send PDCP COUNT information to a receiving side, or receive PDCP COUNT information from a transmitting side, where the PDCP COUNT information includes at least one of the following: a PDCP COUNT value, a PDCP HFN value, or an SN value.

The terminal of the multicast service provided in this embodiment of this application receives the PDCP COUNT information from the transmitting side or send the PDCP COUNT information to the receiving side, where the PDCP COUNT information includes at least one of the following: the PDCP COUNT value, the PDCP HFN value, or the SN value. In this way, the receiving side may obtain the PDCP COUNT value based on the PDCP COUNT information, so as to perform decryption, integrity verification, ordering, or the like on the data packet of the multicast service, thereby improving transmission security of the multicast service.

The terminal 700 provided in this embodiment of this application can further implement the processes of the foregoing embodiment of the indication method for the status variable of the multicast service, and can achieve a same technical effect. To avoid repetition, details are not described herein again.

An embodiment of this application further provides a network side device, including a processor and a communication interface. The communication interface is configured to send PDCP COUNT information to a receiving side, or receive PDCP COUNT information from a transmitting side, where the PDCP COUNT information includes at least one of the following: a PDCP COUNT value, a PDCP HFN value, or an SN value. The network side device embodiment corresponds to the foregoing method embodiment of the network side device. Each implementation process and implementation of the foregoing method embodiment may be applicable to the network side device embodiment, and a same technical effect can be achieved.

Optionally, an embodiment of this application further provides a network side device. As shown in FIG. 8, a network side device 800 includes an antenna 81, a radio frequency apparatus 82, and a baseband apparatus 83. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information by using the antenna 81.

The radio frequency apparatus 82 may be located in the baseband apparatus 83. The method performed by the network side device in the foregoing embodiment may be implemented in the baseband apparatus 83. The baseband apparatus 83 includes a processor 84 and a memory 85.

The baseband apparatus 83 may include, for example, at least one baseband board, where a plurality of chips are disposed on the baseband board. As shown in FIG. 8, one chip is, for example, the processor 84, which is connected to the memory 85, so as to invoke a program in the memory 85 to perform operations of the network side device shown in the foregoing method embodiment.

The baseband apparatus 83 may further include a network interface 86, configured to exchange information with the radio frequency apparatus 82. For example, the interface is a common public radio interface (CPRI).

Optionally, the network side device in this embodiment of this application further includes an instruction or a program stored in the memory 85 and executable on the processor 84. The processor 84 invokes the instruction or the program in the memory 85 to perform the method performed by the modules shown in FIG. 4 or FIG. 5, and a same technical effect is achieved. To avoid repetition, details are not described herein again.

An embodiment of this application further provides a readable storage medium. The readable storage medium may be volatile, non-volatile, or non-transitory. The readable storage medium stores a program or an instruction, and the program or the instruction is executed by a processor to implement the processes of the foregoing embodiment of the indication method for the status variable of the multicast service, and a same technical effect can be achieved. To avoid repetition, details are not described herein again.

The processor is the processor in the terminal described in the above embodiment. The readable storage medium includes a non-transitory computer-readable storage medium, such as a computer read-only memory (ROM), a random access memory (RAM), a magnetic disk, or an optical disc.

An embodiment of this application further provides a chip, where the chip includes a processor and a communication interface. The communication interface is coupled to the processor, and the processor is configured to run a program or an instruction to implement the processes of the foregoing embodiment of the indication method for the status variable of the multicast service, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program product. The computer program product is stored in a non-transitory readable storage medium, and the computer program product is executed by at least one processor to implement the processes of the foregoing embodiment of the indication method for the status variable of the multicast service, and a same technical effect can be achieved. To avoid repetition, details are not described herein again.

An embodiment of this application further provides a communication device, configured to perform the processes of the foregoing embodiment of the indication method for the status variable of the multicast service, and can achieve a same technical effect. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially, or the part contributing to the prior art may be implemented in a form of a computer software product. The computer software product is stored in a non-transitory storage medium (for example, a ROM/RAM, a magnetic disk, or a compact disc), and includes several instructions for instructing a terminal (which may be a mobile phone, a computer, a server, an air conditioner, a network side device, or the like) to perform the method described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. An indication method for a status variable of a multicast service, comprising:
sending, by a transmitting side, packet data convergence protocol count (PDCP COUNT) information to a receiving side, wherein
the PDCP COUNT information comprises at least one of the following: a PDCP COUNT value, a PDCP hyper frame number (HFN) value, or a sequence number (SN) value.

2. The method according to claim 1, wherein the sending, by a transmitting side, PDCP COUNT information to a receiving side comprises at least one of the following:
sending, by the transmitting side, the PDCP COUNT information to the receiving side when the multicast service is established;
sending, by the transmitting side, the PDCP COUNT information to the receiving side in a transmission process of multicast data; or
sending, by the transmitting side, the PDCP COUNT information to the receiving side based on feedback information of the receiving side.

3. The method according to claim 1, wherein
the transmitting side is a network side device, and the receiving side is a terminal; or
both the transmitting side and the receiving side are terminals.

4. The method according to claim 1, wherein the sending, by a transmitting side, PDCP COUNT information to a receiving side comprises at least one of the following:
sending, by the transmitting side, first signaling to the receiving side, wherein the first signaling comprises the PDCP COUNT information;
sending, by the transmitting side, a first data packet to the receiving side, wherein the first data packet comprises the PDCP COUNT information; or
sending, by the transmitting side, a control protocol data unit (PDU) to the receiving side, wherein the control PDU comprises the PDCP COUNT information.

5. The method according to claim 4, wherein in a case that the transmitting side sends the first signaling or the control PDU to the receiving side, the PDCP COUNT information comprises at least one of the following:
PDCP COUNT information corresponding to a next to-be-sent data packet by the transmitting side;
PDCP COUNT information corresponding to a latest sent data packet by the transmitting side;
PDCP COUNT information corresponding to a data packet that has been sent by the transmitting side, wherein the data packet that has been sent does not comprise a latest sent data packet; or
PDCP COUNT information corresponding to a future to-be-sent data packet by the transmitting side, wherein the future to-be-sent data packet does not comprise a next to-be-sent data packet.

6. The method according to claim 4, wherein the sending, by the transmitting side, a first data packet to the receiving side comprises at least one of the following:
sending, by the transmitting side, N first data packets in a case that a new receiving side is determined to join multicast service reception;
sending, by the transmitting side, the N first data packets based on a quantity of data packets that have been sent;
sending, by the transmitting side, the N first data packets based on a running status of a timer; or
sending, by the transmitting side, the N first data packets based on feedback information of the receiving side; and
N is a positive integer.

7. The method according to claim 4, wherein the sending, by the transmitting side, a control PDU to the receiving side comprises at least one of the following:
sending, by the transmitting side, one control PDU in a case that a new receiving side is determined to join multicast service reception;
sending, by the transmitting side, the one control PDU based on a quantity of data packets that have been sent;
sending, by the transmitting side, the one control PDU based on a running status of a timer; or
sending, by the transmitting side, the one control PDU based on feedback information of the receiving side.

8. The method according to claim 4, wherein when the transmitting side sends the first data packet or the control PDU to the receiving side, the sending, by the transmitting side, the PDCP COUNT information to the receiving side comprises at least one of the following:
sending, by the transmitting side, the PDCP COUNT information to the receiving side on a point-to-multipoint (PTM) transmission leg; or
sending, by the transmitting side, the PDCP COUNT information to the receiving side on a point-to-point (PTP) transmission leg.

9. The method according to claim 4, wherein the sending, by the transmitting side, a control PDU to the receiving side comprises at least one of the following:
when a radio link control (RLC) layer of the transmitting side is configured as an acknowledged mode (AM), sending, by the transmitting side, one control PDU to the receiving side;
when an RLC layer of the transmitting side is configured as an unacknowledged mode (UM), sending, by the transmitting side, the control PDU to the receiving side based on hybrid automatic repeat request (HARQ) feedback information at a medium access control (MAC) layer, wherein the HARQ feedback information at the MAC layer indicates whether the control PDU is correctly received by the receiving side; or
sending, by the transmitting side, a plurality of control PDUs or the control PDU for a plurality of times, to the receiving side.

10. The method according to claim 9, wherein the sending, by the transmitting side, the control PDU to the receiving side based on HARQ feedback information at a MAC layer comprises:
in a case that it is determined, based on the HARQ feedback information at the MAC layer, that the control PDU is not correctly received by the receiving side, re-sending, by the transmitting side, the control PDU, to the receiving side; or re-generating, by the transmitting side, a control PDU and sending a re-generated control PDU to the receiving side.

11. The method according to claim 4, wherein
the first data packet comprises indication information for a packet format, the indication information for the packet format indicates a data packet format, and the data packet format comprises a format of the first data packet that carries the PDCP COUNT information or a format of a data packet that carries only an SN value;
the first data packet comprises indication information for a PDU type, the indication information for the PDU type indicates a data packet format, and the data packet format comprises a format of the first data packet that carries the PDCP COUNT information or a format of a data packet that carries only an SN value; or
the first data packet comprises first indication information and a PDCP SN value, and the first indication information indicates whether the PDCP COUNT information exists.

12. The method according to claim 4, wherein the control PDU comprises type indication information, and the type indication information indicates a type of the control PDU, wherein
the type of the control PDU comprises one of the following: a type of the control PDU comprising the PDCP COUNT information, a type of a PDCP status report, a type of robust header compression (ROHC) feedback, or a type of ethernet header compression (EHC) feedback.

13. An indication method for a status variable of a multicast service, comprising:
receiving, by a receiving side, PDCP COUNT information from a transmitting side, wherein
the PDCP COUNT information comprises at least one of the following: a PDCP COUNT value, a PDCP HFN value, or an SN value.

14. The method according to claim 13, wherein after the receiving, by a receiving side, PDCP COUNT information from a transmitting side, the method further comprises one of the following:
obtaining, by the receiving side, a PDCP COUNT value based on the PDCP COUNT information, and initializing a status variable by using the PDCP COUNT value; or
obtaining, by the receiving side, the PDCP COUNT value based on the PDCP COUNT information, and updating a status variable and a receive window by using the PDCP COUNT value.

15. The method according to claim 14, wherein the initializing a status variable by using the PDCP COUNT value comprises one of the following:
initializing RX_NEXT to the PDCP COUNT value plus 1;
initializing the RX_NEXT to the PDCP COUNT value;
initializing RX_DELIV to the PDCP COUNT value minus 0.5×the receive window, wherein when a result of the PDCP COUNT value minus 0.5×the receive window is less than 0, the RX_DELIV is equal to 0;
initializing the RX_DELIV to the PDCP COUNT value plus 1; or
initializing the RX_DELIV to the PDCP COUNT value; and
the RX_NEXT represents a next expected to-be-received variable by the receiving side, and the RX_DELIV represents a first variable that is in a receive window of the receiving side and that is still waiting for reordering and not delivered to a higher layer.

16. The method according to claim 15, wherein the PDCP COUNT information is received in a transmission process of multicast data, and before the initializing a status variable by using the PDCP COUNT value, the method further comprises at least one of the following:
resetting, by the receiving side, the status variable; clearing, by the receiving side, cached data; or deleting, by the receiving side, a reordering timer.

17. The method according to claim 14, wherein the updating a status variable by using the PDCP COUNT value comprises:
updating RX_NEXT to the PDCP COUNT value plus 1; or
when a difference between updated RX_NEXT and RX_DELIV is greater than the receive window, updating the RX_DELIV to the PDCP COUNT value minus 0.5×the receive window; updating the RX_DELIV to the PDCP COUNT value; or updating the RX_DELIV to the PDCP COUNT value plus 1; and
the RX_NEXT represents a next expected to-be-received variable by the receiving side, and the RX_DELIV represents a first variable that is in a receive window of the receiving side and that is still waiting for reordering and not delivered to a higher layer.

18. The method according to claim 17, wherein the method further comprises at least one of the following:
clearing a data packet smaller than RX_DELIV in a cache, and reserving a data packet between the RX_DELIV and the RX_NEXT;
delivering the data packet smaller than the RX_DELIV in the cache to the higher layer in sequence; or
when the RX_DELIV and the RX_NEXT are not equal, starting a reordering timer.

19. A terminal, comprising a processor, a memory, and a program or an instruction stored in the memory and executable on the processor, wherein the program or the instruction, when executed by the processor, causes the terminal to perform:
receiving PDCP COUNT information from a transmitting side, wherein
the PDCP COUNT information comprises at least one of the following: a PDCP COUNT value, a PDCP HFN value, or an SN value.

20. A network side device, comprising a processor, a memory, and a program or an instruction stored in the memory and executable on the processor, wherein when the program or the instruction is executed by the processor, the indication method for the status variable of the multicast service according to claim 1 is implemented.
